(19) United States
(12) Patent Application Publication
(10) Pub. No.: US 2014/0042172 A1
(43) Pub. Date: Feb. 13, 2014

(54) Serving Mat having a Heated or Freezable Internal Medium

(71) Applicant: Alan McNaul, Victoria (CA)

(72) Inventor: Alan McNaul, Victoria (CA)

(21) Appl. No.: 13/572,344

(22) Filed: Aug. 10, 2012

(51) Int. Cl. A47G 23/04; A47J 39/02

(52) U.S. Cl. 220/574.2

(57) ABSTRACT

Disclosed is a serving dish mat adapted to maintain the serving temperature of a supported article and further prevent damage to an underlying support surface. The mat comprises a geometric shape having a thermally insulating base surface, a thermally conductive upper surface and an internal gel-like material therebetween that is readily freezable or heated. The gel material is one of high specific heat capacity and high enthalpy of fusion that is pre-heated or frozen, after which it releases heat or draws heat through the thermally conductive upper surface for maintaining a serving dish temperature resting thereupon. The gel slowly dissipates heat when heated and absorbs considerable heat when frozen prior to returning to a liquid state. The base surface insulates the support surface from the temperature of the internal material, while a serving dish temperature is maintained over a period without active heating or cooling sources.

### BACKGROUND OF THE INVENTION

1. Field of the Invention

The present invention relates to placemats, trivets and serving dishes. More specifically, the present invention relates to a frozen or heated support article that is adapted to support serving dishes, pots, drinks and other food containers thereon for the purposes of retaining their optimum serving temperature.

Serving and presenting food during an event or meal generally involves placing heated or chilled food onto a serving dish and displaying the articles in a location that allows individuals to readily remove the food articles therefrom for consumption. Generally this involves either placing food onto a plate or dish and rapidly transferring the food to individual dinner plates for consumption, or placing the food in a container or tray that is temperature controlled for maintaining the food serving temperature over periods of time. The latter is generally reserved for larger parties or events, wherein food is displayed and consumed over a period of time, and the food temperature is maintained in catering trays and serving dishes having a means of temperature regulation. These devices regulate the tray and food temperature using a burner or heating element, or in the case of chilled food a quantity of ice is utilized. This maintains the optimum serving temperature of the food while users are able to choose their food over a period of time without worrying about food spoilage or improper serving temperature thereof.

Serving trays of this type are well known in the art and are well adapted for maintaining the temperature of a food product during an event. However, these devices are more appropriate for larger events and gatherings, as opposed to smaller parties or family dinners wherein large food trays are not always necessary or convenient. The present invention relates to a serving mat that is adapted to provide an improved means of maintaining a food product serving temperature without large assemblies or active heating means. Specifically, the present invention provides a serving mat that includes an internally heated or frozen material and structure that readily heats or cools a serving dish placed thereon for a period of time, preventing the food from spoiling or losing its ideal serving temperature. The present invention further provides a means of protecting a countertop or table support surface, in a similar fashion as a trivet or placemat. The base of the present invention comprises a thermally insulative layer that shields the support surface from extreme temperatures to prevent damage and exposure thereof, while the upper surface of the present invention readily transfers heat therethrough. In this way, the present invention serves as a serving mat that regulates the temperature of an article placed thereon, while shielding the surface below from large temperature variations.

2. Description of the Prior Art

Devices have been disclosed in the prior art and are available in the market for supporting food products and maintaining their serving temperature. These devices are mostly related to insulating serving mats or food trays that either shield a support surface or provide an active means of regulating a food product temperature. These include devices that have been patented and published in patent application publications. The devices deemed most relevant to the present disclosure are herein described for the purposes of highlighting and differentiating the unique aspects of the present invention, and further highlighting the drawbacks existing in the prior art. Most notably there exists a need for a new and improved serving mat that is able to shield a support surface while simultaneously maintaining a food product serving temperature. The present invention fulfills this need and advances the art in the area of mats and serving trays.

One such device disclosed in the prior art is U.S. Pat. No. 4,550,894 to Barlics, which discloses a trivet made from a continuous ring having openings which form a dead air space between an objected supported thereon and an underlying surface. The trivet is comprised of a heat-resistant, non-slip material such that the assembly will not slide along a supporting surface and the trivet will serve as a heat resistive layer in which heat transfer to the support surface is reduced. While the Barlics device discloses a mat for supporting an article and for reducing heat transfer to a supporting surface, the Barlics device is not well adapted for preserving the temperature of the supported article for periods of time. The Barlics device is more adapted to be a thermally insulative layer upon which hot objects are placed, wherein the support surface is prevented from being exposed to extreme temperature due to the material and open air shape of the trivet.

Another device is U.S. Pat. No. 5,598,946 to Davis, wherein an insulated fabric serving dish holder is disclosed, comprising a bottom panel and an upstanding side panel that is adapted to protect the hands of servers when handling hot serving dishes. The side panel is a thermally insulating fabric that serves as a thermal boundary and a decorative sidewall around the perimeter of the device. The side panel and bottom panel are shaped to fit around the perimeter of a serving dish, while fasteners located on the termination ends of the disconnected side panel secure the assembly around the serving dish prior to handling. While discloses a novel and decorative serving dish holder, the Davis device does not contemplate a dish support structure that is adapted to maintain the serving temperature of a support pot, plate or dish.

Further, U.S. Pat. No. 7,124,446 to Demay discloses a potholder that provides hand protection while handling heated pots and serving dishes. The potholder comprises a generally rectangular body having two outer surfaces, and insulating material within the body and two pockets along the body adapted to receive a user's fingers and thumb therein. The thickness of the potholder and its construction shield the user's hand from heat radiating from the heated object, preventing accidental burns. The flexibility of the material and the construction thereof provides a unique potholder and thermal barrier for users to carry and handle heated objects. The Demay device, however, diverges in spirit from the present invention, which is more directed to a thermally conductive support surface and one that shields its supporting surface from temperature variations. The present invention, specifically, is a dish or plate support article that includes the ability to be heated or cooled, providing the supported article with a means to maintain its serving temperature for prolonged periods.

U.S. Pat. No. 6,684,460 to Cuff discloses another potholder, wherein a rectangularly shaped cloth material is provided, comprising a plurality of folds in the material that form shaped layers that are coupled together. Stitching along the outer edge of the layers and stitching across the pot holder body section allow the structure to fold in substantially any direction, which allow the potholder assembly to better conform to an article being handled. This prevents awkward bend points and internal chambers from forming in the potholder body, which can let heat to pass through or expose the user to the surface of a heated object. Similar to the Demay device, the Cuff device provides a handheld potholder device for handling heated articles, which diverges in elements and spirit from the present invention. The present invention is adapted to support an article along its upper surface and maintain its operating or serving temperature, wherein otherwise the article may dissipate heat rapidly once removed from a cooking or heating source.

Finally, U.S. Published Patent Application Publication Number 2007/0082164 to Sellers discloses a multi-purpose mat for heated items having a single, flexible and thing body elastomeric structure that is easily cut along grooves for shaping the mat to suit a particular application. The grooves include a score line along their bottom surface, while raised portions between grooves act as a cushion for dishes and other articles that desire a support while protecting a countertop support surface. The material of the mat is adapted to provide a heat barrier between a heated object and a support surface up to 600 degrees Fahrenheit, which prevents burning and damage to the support surface when placing a heated object on the disclosed mat. The Sellers device, while providing an easily modifiable mat structure and one that is thermally resistant, provides no means to maintain an article temperature while also providing a thermal barrier between a heated article and the support surface. The present invention serves two functions: a serving dish support mat that maintains a desired serving temperature, and further a thermally resistant mat that prevents burning or damage to the support surface therebelow.

The present invention is a heating and cooling mat that allows a user to place a food product or article onto the mat upper surface to retain a desired temperature over a period of time, while also shielding the underlying support surface from the temperature of the food product and the temperature of the heating material within the mat interior. The present invention provides a new and improved structure that is well adapted for serving food products in a residential or commercial environment, wherein larger heating or cooling assemblies may not be desired. The structure and spirit of the present invention substantially diverges in design elements from the prior art, and consequently it is clear that there is a need in the art for an improvement to existing serving mat devices. In this regard the instant invention substantially fulfills these needs.

### SUMMARY OF THE INVENTION

In view of the foregoing disadvantages inherent in the known types of serving mats and trays now present in the prior art, the present invention provides a new serving mat and means of temperature regulation, wherein the same can be utilized for providing convenience for the user when serving chilled or heated food articles on the disclosed mat over a prolonged periods.

It is therefore an object of the present invention to provide a new and improved serving mat device that has all of the advantages of the prior art and none of the disadvantages.

It is another object of the present invention to provide a serving mat that is adapted to maintain the serving temperature of a food article placed on its upper surface for a period of time, wherein the food may be chilled or heated.

Another object of the present invention is to provide a serving mat that includes an internal gel material that is readily frozen or heatable, wherein the material is adapted retain its heated temperature or require considerable heating energy to transform the material from a frozen to a liquid state.

Yet another object of the present invention is to provide a serving mat having a structure that allows ready heat transfer through the upper surface of the mat, wherein a serving dish placed thereon readily receives heat conducted from the gel material or heat is readily absorbed from the serving dish and into the gel material for maintaining the food's chilled temperature.

Another object of the present invention is to provide a serving mat having a lower surface that shields a support surface, wherein the lower surface of the mat is thermally insulated to prevent heat damage to the supporting surface or a user's hand supporting the assembly.

A final object of the present invention is to provide a serving mat that may be formed in a variety of shapes, styles and fashions to suit a particular environment or user need.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross section view of an embodiment of the present mat, wherein its internal structure is visualized.

FIG. 2 there is shown an overhead view of an embodiment of the present mat, wherein a section is removed for viewing its internal structure.

FIG. 3 there is shown a view of the present mat in a working state support a serving dish and chilled food products thereon.

FIG. 4 there is shown an overhead view of an alternate embodiment of the present invention.

FIG. 5 there is shown a side view of an alternate embodiment of the present invention.

### DETAILED DESCRIPTION OF THE INVENTION

Reference is made herein to the attached drawings. Like reference numerals are used throughout the drawings to depict like or similar elements of the serving mat. For the purposes of presenting a brief and clear description of the present invention, the preferred embodiment will be discussed as used for maintaining the temperature of food products and serving dishes placed on its upper surface and preventing damage to an underlying support surface. The figures are intended for representative purposes only and should not be considered to be limiting in any respect.

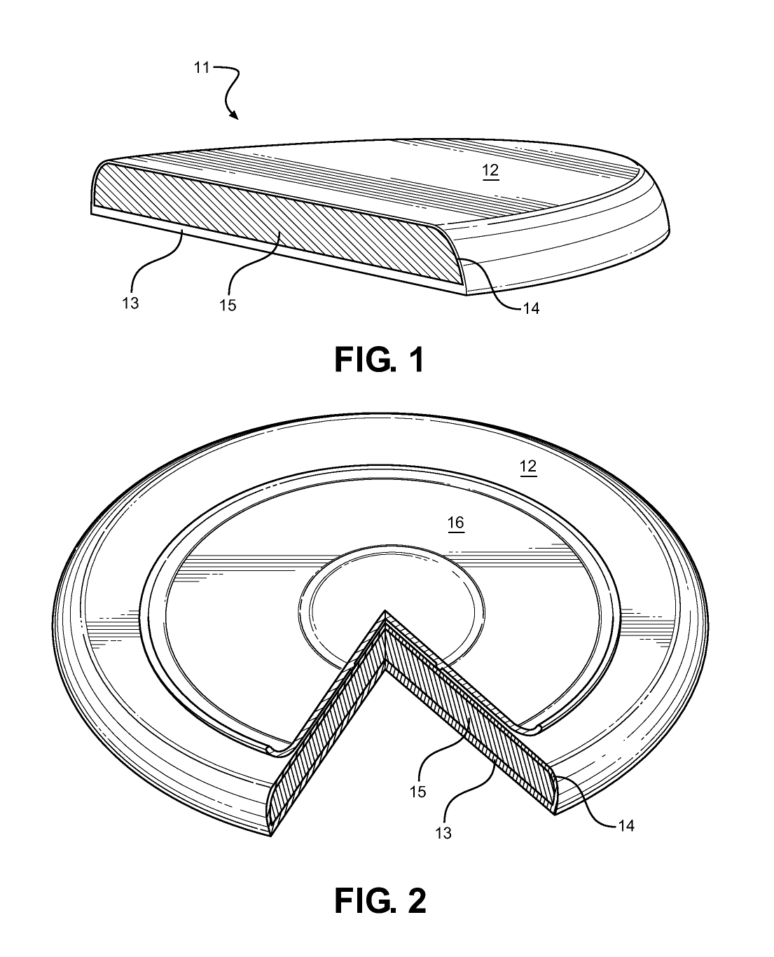

Referring now to FIGS. 1 and 2, there are shown a perspective cross section views of the present invention, wherein the internal structure of the device is visualized. The present invention comprises a heating and cooling mat 11 adapted to support a serving dish 16 and maintain the temperature of articles on the dish for a period of time. The construction of the mat includes a base surface 13 connected to an upper surface 12 that houses an internal core of freezable and heatable material 15 therebetween. The base surface 13 is an insulating surface and one that prevents an underlying surface from experiencing the temperature of the mat core material 15. This surface is comprised of an insulating material or the same material as the upper surface but having a greater thickness to increase its heat resistance and thus reduce heat transfer across its cross section. The upper surface 12 comprises a conductive material that allows ready transfer of heat to and from the core material 15 through its thickness, wherein a positioned serving tray or dish on the upper surface 12 may be heated or chilled. Alternatively the upper and lower surface may comprise of a unitary material, wherein the upper surface thickness is thinner than the base surface, whereby it is desired to allow transfer of heat from the core material 15 through the upper surface 12 and restrict heat transfer through the lower surface 13.

The mat assembly is adapted to be heated or frozen prior to be deployed on a work surface and utilized as a serving mat. Prior to deployment, the mat may be placed into a freezer, allowing the core material 15 to freeze solid. Alternatively and for heated applications, the mat assembly may be placed into a microwave oven or traditional oven, wherein its core material temperature is elevated. Once removed from the freezer or oven, the material 15 is adapted to retain its frozen state or heated state for a period of time, releasing its heat for food warming purposes or chilling a cold dish as the material melts into a liquid state. The material is ideally one that comprises a high specific heat and high enthalpy of fusion, wherein heat dissipates slowly from the device if heated and considerable energy is required to change its phase from a frozen solid to a room temperature liquid state. Preferably the core material 15 is a gel-like material, comprising a solution of water and propylene glycol utilized in most reusable heating and cooling pads for therapeutic purposes, wherein the material comprises a specific heat and enthalpy of fusion greater than or at least equal to that of water. The material is a gel or alternatively granular clay material that is readily freezable or heatable to comprise a dual function serving mat that accommodates articles adapted to be chilled or heated. The core material located is further flexible and malleable when unfrozen, accepting the shape of a serving ware placed on its upper surface to facilitate heat transfer thereto.

The mat upper and lower surface material may be silicone rubber, vinyl, or fabric material, or alternatively the upper surface may comprise of a metallic structure and the base may be of a cork or similarly insulating material. The shape, size and ornamentation of the mat is one that can be chosen for a specific occasion, including very simply designed mats or those that are more elaborate or decorative for formal occasions. The outer material may be a variety of colors, textures, plain, or patterned to suite the taste of the user. In one embodiment, the mat is circular, having a thickness to accommodate for the upper surface 12, lower surface 13 and core material 15, wherein the perimeter of the circle is a sidewall 14 of the same thickness as the upper surface 12.

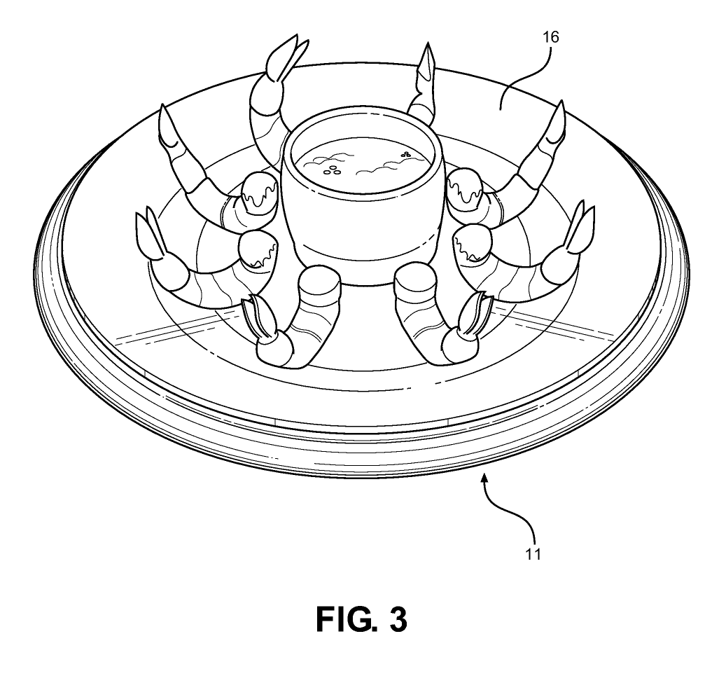

Referring now to FIG. 3, there is shown an overhead perspective view of the present invention in a working position. As shown, the serving mat 11 is positioned on a support surface and a chilled serving dish 16 is positioned along the upper surface of the mat. Prior to deployment, the mat 11 is placed in a freezer or ice chest to be frozen solid. After removal and subsequent placement beneath a serving dish 16, the mat remains frozen for an extended period until absorbing enough energy to return the gel to a liquid state. During this period, the mat is chilling the plate for the purposes of maintaining the serving temperature of the food thereon. The countertop or support surface is not exposed to the extreme temperature of the core material, as the core is insulated to prevent damage to the supporting surface.

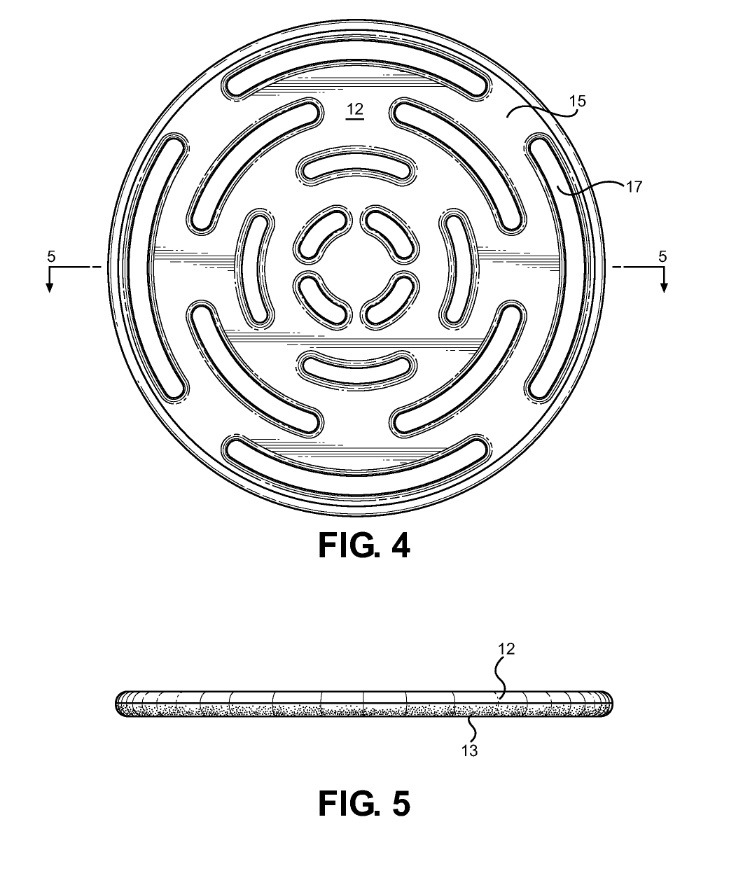

Referring finally to FIGS. 4 and 5, there is shown an overhead and side view of an alternate embodiment of the present invention, which includes a rounded structure having a thinner cross section and interior apertures 17 provided to trap heat therein and further retain the serving dish temperature. In this embodiment, the mat includes a smaller core of gel-like material, an upper surface 12 adapted to contact a serving dish and a lower insulating surface 13 adapted to prevent large amounts of heat from flowing through the base of the mat. This construction is similar to the preferred embodiment, however with added apertures through its cross section and a shape having a slightly different ornamental design. It is not desired to limit the present invention to a specific shape or design, but rather it is desired to disclose a mat construction that functions as a heating or cooling device for serving dishes at a desired serving temperature. The upper and lower surfaces may be comprised of silicon, vinyl, cork, rubber, cotton batting or metallic material, depending on the application and user preferences.

The following is a list of several structural configurations that have been shown to be an effective implementation of the present invention:

TABLE 1
Mat Construction Embodiments

| | Base Surface | Core Material | Upper Surface |
|---|---|---|---|
| 1) | 0.0625 inch silicone | 1.2 inch gel | 0.005 inch silicone |
| 2) | 0.0625 inch silicone | 1.2 inch gel | 0.005 inch silicone |
| 3) | 0.0625 inch silicone | 1.2 inch gel | 0.005 inch vinyl |
| 4) | 0.005 inch silicone + | 1.2 inch gel | 0.005 inch silicone |
| | 0.0625 insulation | | |
| 5) | Vinyl + 0.0625 insulation | 1.2 inch gel | 0.005 inch vinyl |
| 6) | Vinyl + 0.0625 insulating | 1.2 inch gel | 0.005 inch silicon |

The upper and lower surfaces of the present mat serve opposite functions, however the material that defines the outer surface of the mat may be of uniform material type while still accomplishing both goals. For ease of manufacturing, it is realized that uniform material is easier and cheaper to build, therefore the upper surface may be of thinner cross section than the base, wherein the larger thickness increase thermal resistance and thus overall heat transfer therethrough. It has been shown that silicone, vinyl, cotton batting and fabric are well suited for the exterior of the present device, wherein the relative thickness of the upper and lower surfaces determines where heat more readily escapes.

When hot or cold food is placed in a serving dish and served on a surface, the serving dish will naturally adopt the same temperature of the serving surface affecting the temperature of the food it contains. The hot or cold serving dish may also cause damage to the serving surface. To prevent these problems, consumers may invest in serving ware, specially designed to maintain food temperatures and protect table top surfaces. However, these products can be very costly, and may not be practical for many individuals. The present invention is therefore disclosed for preserve optimal temperatures of the food in the dishes, while also protecting table tops and other similar surfaces from dishes that may be extremely hot or cold. The present invention features thermally insulated and conductive surfaces and an overall portable construction, wherein an internal gel core is readily frozen or heated for the purposes of heating or chilling a serving dish. Users can place the mats in the freezer or heat the assembly briefly in the microwave prior to use, depending on the temperature of the food being served. In use, the present mat is placed below a serving dish and keeps the dish temperature at an optimum level for serving and consuming the articles thereon over an extended period.

In light of the prior art that the present disclosure, it is herein submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A serving dish heating and cooling mat, comprising:
a base surface having a thickness,
an upper surface having a thickness and connecting to said base surface;
an internal core material sandwiched between said upper and lower surfaces;
said core material being freezable and heatable, wherein said core transfers heat through said upper surface for heating or chilling an article placed thereon;
said base surface being of higher thermal resistance than said upper surface.

2) The device of claim 1, wherein said internal core material comprises a material having a specific heat and enthalpy of fusion greater or equal to that of water.

3) The device of claim 1, wherein said inner core material comprises a solution of water and propylene glycol.

4) The device of claim 1, wherein said upper surface and base surface are of uniform material type, wherein said base surface thickness is greater than said upper surface thickness to increase thermal resistance of said base surface.

5) The device of claim 1, wherein said upper surface and base surface are of uniform material type and thickness, wherein said base surface further comprises a layer of insulation material thereunder for increasing said base surface thermal resistance.

6) The device of claim 1, further comprising a plurality of apertures extending from said upper surface, through said core and through said base surface.

7) The device of claim 1, wherein said core material comprises a reusable heating and cooling pad gel material that is readily freezable and heatable.

8) The device of claim 1, wherein said core material is liquid at room temperature.
